(19) United States
(12) Patent Application Publication
(10) Pub. No.: US 2010/0157353 A1
(43) Pub. Date: Jun. 24, 2010

(54) Method and Image Forming Device for Generating Print Output

(76) Inventor: John Thomas Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/341,684

(22) Filed: Dec. 22, 2008

(51) Int. Cl. G06F 3/12

(52) U.S. Cl. 358/1.15

(57) ABSTRACT

The invention describes a method and an image forming device for generating a print output. The image forming device analyzes an input image with respect to a target media sheet and identifies a white space region. Based on the identification, the image forming device generates a print output by automatically inserting one or more ruled-lines in the identified white space region.

### BACKGROUND

1. Field of the Invention

The present invention relates generally to an image forming device, and more particularly, to a method and system for generating a print output in the image forming device.

2. Description of the Related Art

Image forming devices such as printers, scanners and copiers process images and produce a copy of it as an output. The image forming device may produce the output by printing a replica of the image on print media such as paper sheets. It is a common occurrence that the image printed on the paper sheets may include content region which does not cover a complete print area of a paper sheet. When such an image is printed a considerable amount of white space region may remain unused on the paper sheet. Thus, printing only a small content region on the paper sheet and leaving a considerable amount of white space region unutilized may lead to sub-optimal utilization of resources.

Also, in some cases, to maintain a set of printed documents in an organized manner, a user may prefer to insert the paper sheets in a file. In addition to the paper sheets, the user may also prefer to insert a separate set of pages for taking handwritten notes. Thus, the user may have to maintain separate sheets and pages in the file, thereby increasing the consumption of papers which results in wastage of paper. Further, the user may need to maintain a large volume of papers in the file which sometimes becomes unmanageable and causes inconvenience to the user.

### SUMMARY OF THE INVENTION

The embodiments of the present invention overcome the limitations of prior image forming devices, thereby satisfying a need for a method and an image forming device for generating a print output. Various embodiments of the present invention are capable of improving the utilization of print media and reducing the paper consumption by supplanting the need for a separate set of pages for taking notes. Further, the image forming device according to the embodiments of the present invention minimizes a paper volume accumulation rate for a user.

The embodiments of the present invention provide a method, image forming device and computer program product for generating a print output. Such an image forming device may include an input image analyzer, a white space identifier, a print output generator and a printing mechanism. The input image analyzer may analyze an input image with respect to a size of a target media sheet on which the input image needs to be printed. The white space identifier may then identify a white space region. Based on the identification, the print output generator may generate the print output by inserting one or more images, such as ruled-lines, in the identified white space region. The print output having the one or more images may then be printed by the printing mechanism on the target media sheet.

In an embodiment of the invention, a user may configure a minimum white space region before inserting the images in the print output. In another embodiment of the invention, the print output generator may selectively insert the ruled-lines based on certain parameters specified by the user, for example whether the print output is single-sided, whether the print output is monochrome, whether the media sheet is plain paper and so forth. In yet another embodiment of the invention, a root image, such as a single line with spacing, a single line without spacing, a tile, or a vector graphic may be stored in a memory of the image forming device. At the time of insertion, the root image may be fetched from the memory by the print output generator.

The method and image forming device according to the embodiments of the present invention generate a print output in an image forming device by providing alternative ways/methods of inserting one or more images in the print output. The image forming device may also reduce the consumption of print media considerably by utilizing the same print media with one or more images inserted, such as ruled-lines, for taking notes. Moreover, the method may also reduce the paper volume accumulation rate for a user. Thus, the image forming device supplants the need for maintaining a separate set of pages for taking notes.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1A and 1B are an illustration of a conventional media sheet and a conventional page as is known in the art;

FIG. 2 is an illustration of an image forming device, in accordance with an exemplary embodiment of the invention;

FIG. 3 is a block diagram illustrating an exemplary insertion of one or more ruled-lines in a print output, in accordance with an embodiment of the invention;

FIG. 4A is a block diagram illustrating an exemplary insertion of one or more ruled-lines in a print output, in accordance with an exemplary embodiment of the invention;

FIG. 4B is a block diagram illustrating another exemplary insertion of one or more ruled-lines in a print output, in accordance with another exemplary embodiment of the invention; and

FIG. 5 depicts a flowchart illustrating an exemplary method for generating a print output in an image forming device, in accordance with an exemplary embodiment of the invention.

### DETAILED DESCRIPTION OF DRAWINGS

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that the embodiments of the invention include both hardware and electronic components or modules that, for purposes of discussion, may be illustrated and described as if the majority of the components were implemented solely in hardware. However, one of ordinary skill in the art, and based on a reading of this detailed description, will recognize that, in at least one embodiment, the electronic-based aspects of the invention may be implemented in software. As such, it should be noted that a plurality of hardware- and software-based devices, as well as a plurality of different structural components, may be utilized to implement the invention. Furthermore, as described in the subsequent paragraphs, the specific configurations illustrated in the drawings are intended to exemplify the embodiments of the invention and that other alternative configurations are possible.

The embodiments of the present invention provide an image forming device, method and computer program product for generating a print output. The term “image” as used herein encompasses any printed or digital form of text, graphics, or a combination thereof. The term, “image forming device” as used herein encompasses devices such as color and black-and-white copiers, color and black-and-white printers, color and black-and-white scanners, fax machines, and so-called “all-in-one devices” that incorporate multiple functions such as scanning, copying, and printing capabilities in one device. Such image forming devices may utilize ink jet, dot matrix, dye sublimation, laser, and any other suitable print formats.

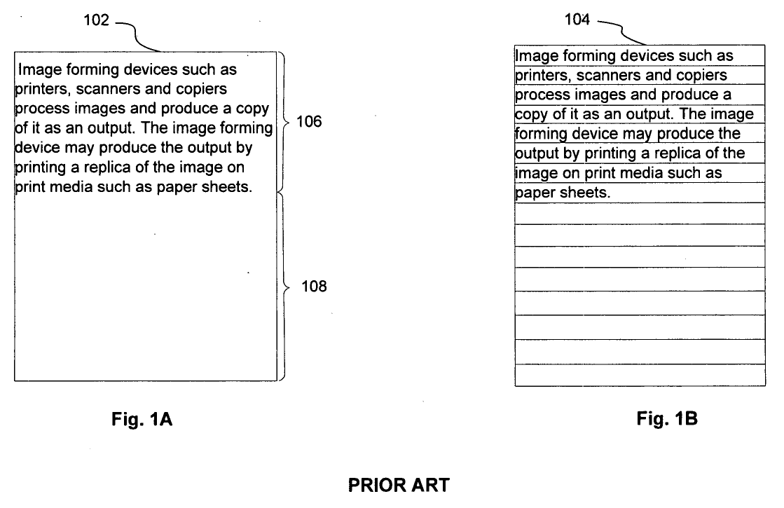

FIGS. 1A and 1B are an illustration of a conventional media sheet 102 and a conventional page 104 as is known in the art. FIG. 1A represents conventional media sheet 102 produced by an image forming device. Examples of conventional media sheet 102 include, but are not limited to, a paper, a cardstock, a transparency, a label, an envelope and any other suitable print media. FIG. 1B represents conventional page 104 having ruled-lines which may be used by a user for taking notes.

As depicted in FIG. 1A, conventional media sheet 102 includes a content region 106 and a white space region 108 which may remain unused. Similarly, in spite of white space region 108 left in a print output such as conventional media sheet 102, the user may prefer to use one or more conventional pages 104, as shown in FIG. 1B, for taking notes in a neat and straight manner. As a result, the user may have to maintain separate sets of conventional media sheets 102 and conventional pages 106. This may increase the accumulation of conventional media sheets 102 and conventional pages 104 for the user. Hence, the user may need to handle a large volume of conventional media sheets 102 and conventional pages 104 which may become unmanageable and may also cause inconvenience to the user. Also, many a times, the user may not print on the reverse side of conventional media sheets 102 which may again lead to sub-optimal utilization of print media.

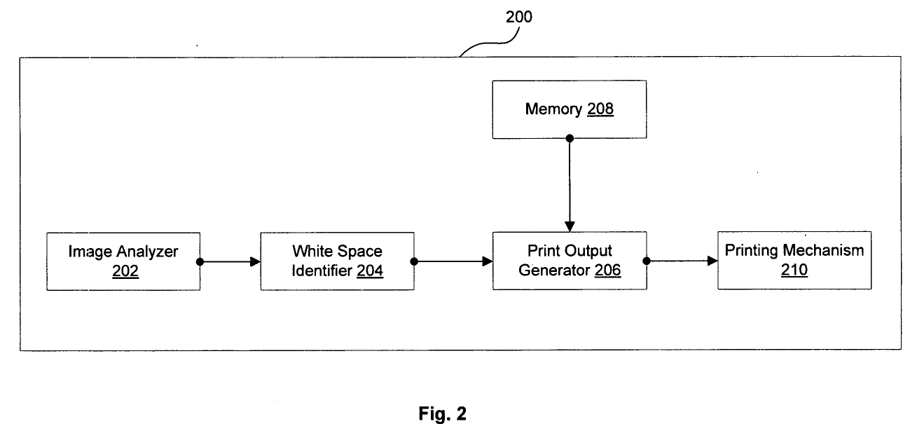

FIG. 2 is an illustration of an image forming device 200, in accordance with an exemplary embodiment of the invention. Image forming device 200 includes an image analyzer 202, a white space identifier 204, a print output generator 206, a memory 208 and a printing mechanism 210.

A user may intend to provide one or more media sheets or one or more documents to image forming device 200 for image formation. In an embodiment of the invention, image forming device 200 may process an electronic document stored in a memory and may print the processed electronic document on the media sheets received from the user. In another embodiment of the invention, image forming device 200 may process the documents received from the user containing text, graphics, or a combination thereof, and may then print the processed documents on media sheets included in a media tray of image forming device 200. Image forming device 200 may also conform to a set of predefined conditions in accordance with various embodiments of the invention for printing of one or more images such as one or more ruled-lines on a target media sheet.

Image analyzer 202 may analyze an image of the electronic document or the one or more documents with respect to a size of the target media sheet on which the image needs to be printed. In an exemplary embodiment of the invention, image forming device 200 may be a printer and image analyzer 202 may be printer software that receives the image of the electronic document from an application such as Microsoft® Word, Microsoft® PowerPoint® and the like. In another exemplary embodiment of the invention, image forming device 200 may be one of a scanner, a copier, a fax machine or an ‘all-in-one’ device and image analyzer 202 may be software that analyzes the image of the documents received from the user. Thus, image analyzer 202 may analyze the image with respect to the size of the target media sheet and may forward the analyzed image to white space identifier 204 for identifying a white space region.

White space identifier 204 may then identify the white space region. In various embodiments of the invention, the white space region may be identified in at least one of the image, the layout of the target media sheet or both. In an embodiment of the invention, the image may include a content region containing text, graphics or a combination thereof. The image may further include one or more predefined areas such as borders, header and footer, letterheads and the like. White space identifier 204 may identify white space regions by excluding or ignoring the predefined areas. Thereafter, white space identifier 204 may confirm whether the identified white space region is greater than a predetermined size. For example, the user may define a minimum white space region size which might be needed in the target media sheet. Based on the confirmation, white space identifier 204 may then forward the identified white space region to print output generator 206.

Thereafter, print output generator 206 may selectively insert the ruled-lines in the identified white space region. Print output generator 206 may then generate a print output including the content region of the image, the predefined areas and the ruled-lines.

In another embodiment of the invention, a root image, such as a single line with spacing, a single line without spacing, a tile, or a vector graphic may be stored in memory 208. At the time of insertion, the root image may be fetched from memory 208 by print output generator 206. Print output generator 206 may then automatically insert the root image by repeating the root image in the identified white space region. Print output generator 206 may then generate the print output including the content region of the image, the predefined areas and the root images.

In yet another embodiment of the invention, print output generator 206 may insert the ruled-lines during a half-toning operation by applying one or more algorithms.

In accordance with various embodiments of the invention, printing mechanism 210 may print the print output generated by print output generator 206 on the target media sheet.

In accordance with various embodiments of the invention, a user may be prompted by image forming device 200 to confirm the insertion of the ruled-lines in the identified white space region. Prompting the user may include, for example, confirming the insertion of the ruled-lines through alternative options or ways, such as one or more message alerts, a dialog box and the like. The user may select an option ‘yes’ for confirming the insertion of the ruled lines. Similarly, the user may also choose to ignore the insertion of the ruled lines by either closing the option or by selecting an option ‘no’. Additionally, the user may also check a ‘Don't ask me again’ checkbox in the options to avoid such prompts in the future. Print output generator 206 may be activated based on the user inputs.

In another exemplary embodiment of the invention, image forming device 200 may provide a print preview to the user on a display device. The print preview may include the print output of the image including the inserted ruled-lines. The user may then opt for printing the print output on the target media sheet. In an embodiment of the invention, the user may modify the print output by specifying various regions in which the ruled-lines should be inserted. Similarly, the user may also modify the print output by deleting some of the ruled-lines from the generated print output.

In accordance with various embodiments of the invention, the user may intend to define the set of predefined conditions in image forming device 200 for printing the ruled-lines on the target media sheet. In an embodiment of the invention, the user may configure image forming device 200 to print the ruled-lines on the basis of the ‘type’ of print output. For example, image forming device 200 may be configured to print the ruled-lines only when the print output is monochrome. In an embodiment of the invention, in case of multi-page image print command, image forming device 200 may be configured not to insert the ruled-lines in the print output of any multi-page image. Similarly, in another embodiment of the invention, image forming device 200 may be configured to selectively insert the ruled-lines in the print output of the one or more images of the multi-page image. In yet another embodiment of the invention, image forming device 200 may be configured to print the ruled-lines only when the target media sheet is plain paper. In this case, image forming device 200 may not print the ruled-lines when the target media sheet is a transparency, an envelope, a label and the like. In another embodiment of the invention, image forming device 200 may be configured to print the ruled-lines only on the reverse side of the target media sheets. In various embodiments of the invention, any combination of the above configurations of image forming device 200 may be used thereof.

In an embodiment of the invention, the user may adjust at least one of color, darkness, size, spacing or a combination thereof of the ruled-lines.

In another embodiment of the invention, the ruled-lines are inserted in the identified white space regions in the form of at least one of one or more horizontal ruled-lines, one or more vertical ruled-lines or a combination thereof.

In yet another embodiment of the invention, print output generator 206 may insert one or more images such as logos, artifacts, watermarks and the like in the print output.

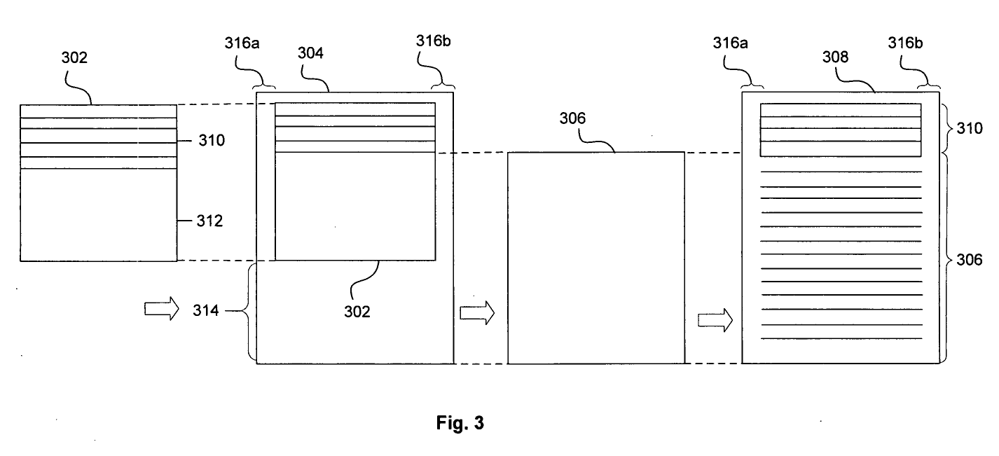

FIG. 3 is a block diagram illustrating an exemplary insertion of one or more ruled-lines in a print output, such as a print output 308, in accordance with an embodiment of the invention. The block diagram includes an exemplary image 302 to be processed, an exemplary layout of a target media sheet 304, an identified white space region 306 and print output 308. Image 302 includes a content region 310 and a white space region 312.

Image forming device 200 may create image 302 of one or more documents provided by a user for image formation. Thereafter, image analyzer 202 may analyze image 302 with respect to target media sheet 304. In an embodiment of the invention, image analyzer 202 may generate a layout of target media sheet 304 considering that image 302 is printed on target media sheet 304. Thereafter, white space identifier 204 may identify the white space in image 302, depicted as white space region 312. White space identifier 204 may also identify a white space region illustrated as a remaining white space region 314 in the layout of target media sheet 304. Additionally, white space identifier 204 may identify one or more predefined areas illustrated as predefined areas 316a and 316b in the layout of target media sheet 304. White space identifier 204 may then identify the total white space region in the layout of target media sheet 304 by excluding the predefined areas such as predefined areas 316a and 316b. Thus, identified white space region 306 may include white space region 312 and remaining white space region 314. Subsequently, print output generator 206 may generate a print output illustrated as print output 308 including content region 310 and the inserted ruled-lines in identified white space region 306. Finally, printing mechanism 210 prints print output 308 on target media sheet 304.

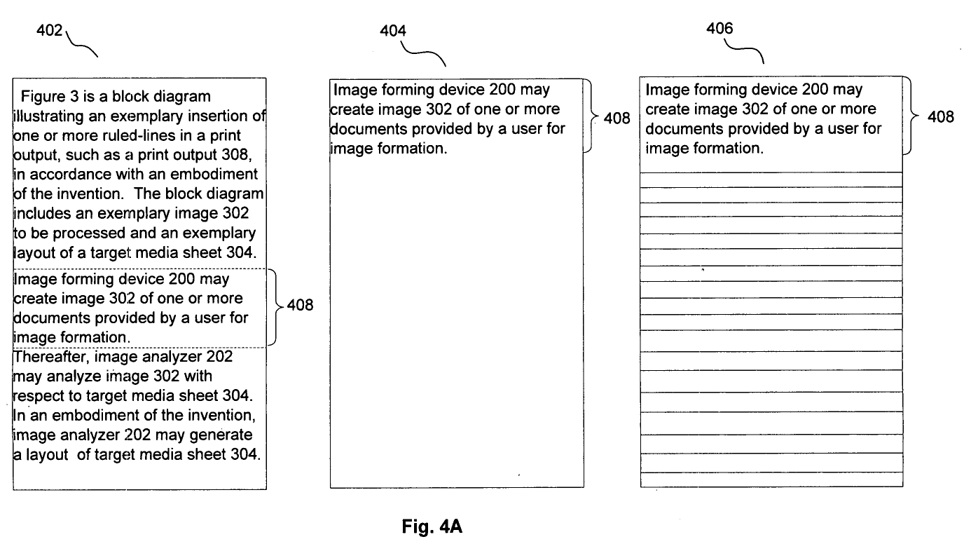

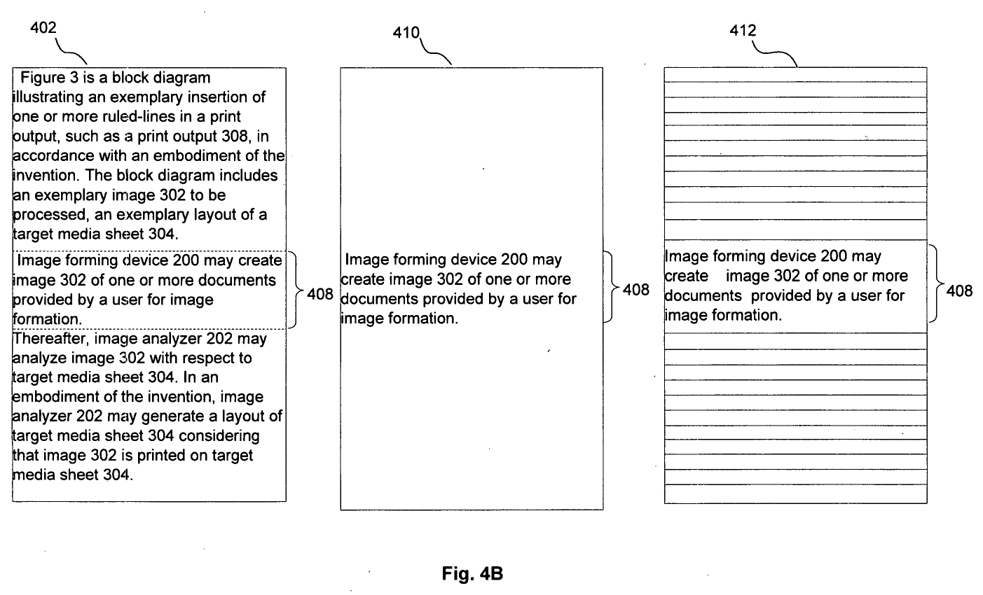

FIG. 4A is a block diagram illustrating an exemplary insertion of one or more ruled-lines in a print output, such as a print output 406, in accordance with an exemplary embodiment of the invention. FIG. 4A includes an exemplary electronic document 402, an exemplary layout of a target media sheet 404 and print output 406. Electronic document 402 includes a selected content region 408.

As depicted in FIG. 4A, a user may select a section of text or graphics in electronic document 402 such as selected content region 408 to be processed by image forming device 200. Thereafter, image forming device 200 may form an image of selected content region 408. Subsequently, image analyzer 202 may analyze the image of selected content region 408 with respect to target media sheet 404. In an embodiment of the invention, image analyzer 202 may generate a layout of target media sheet 404 considering that the image of selected content region 408 is printed on target media sheet 404. Thereafter, white space identifier 204 may identify a white space region in the layout of target media sheet 404. Subsequently, print output generator 206 may generate a print output such as print output 406 by insert ruled-lines in the identified white space region. Finally, printing mechanism 210 prints print output 406 on target media sheet 404.

FIG. 4B is a block diagram illustrating another exemplary insertion of one or more ruled-lines in a print output, such as a print output 412, in accordance with another exemplary embodiment of the invention. FIG. 4B includes the exemplary electronic document 402, an exemplary image 410 to be processed and print output 412. Electronic document 402 includes selected content region 408.

As depicted in FIG. 4B, image forming device 200 may form an image such as image 410 of complete electronic document 402 including only selected content region 408. The orientation of selected content region 408 in image 410 may remain the same as in electronic document 402. Thus, print output generator 206 may generate a print output such as print output 412 by inserting ruled-lines in the remaining white space region of image 410.

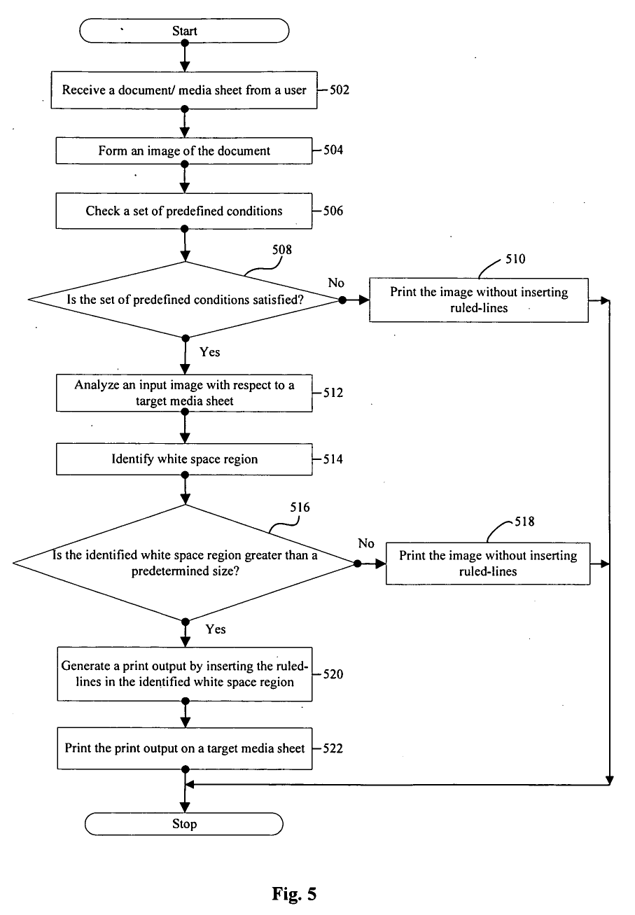

FIG. 5 depicts a flowchart illustrating an exemplary method for generating a print output in an image forming device, such as image forming device 200, in accordance with an embodiment of the invention.

At 502, the image forming device may receive a document from a user for processing. At 504, the image forming device may form an image of the document. At 506, as explained in conjunction with FIG. 2, the image forming device may check a set of predefined conditions for printing one or more ruled-lines on a target media sheet. Thereafter, at step 508, the image forming device may confirm that the set of predefined conditions are satisfied. If the set of predefined conditions are not satisfied, then, at 510, the image forming device may process the image without printing the ruled-lines on the target media sheet. However, if the set of predefined conditions are satisfied, then, at 512, an image analyzer of the image forming device such as image analyzer 202 may analyze the image with respect to the target media sheet on which the image needs to be printed.

At 514, a white space identifier of the image forming device such as white space identifier 204 may identify the white space region as described in conjunction with FIGS. 2, 3, 4A and 4B.

Thereafter, at 516, the white space identifier may confirm whether the identified white space region is greater than a predetermined size. In an embodiment of the invention, if the identified white space region is not greater than the predetermined size, then, at 518, the image forming device may process the image without printing the ruled-lines on the target media sheet. In another embodiment of the invention, if the identified white space region is greater than the predetermined size, then at 520, a print output generator such as print output generator 206 may generate a print output by inserting the ruled-lines in the identified white space region. In an embodiment of the invention, a root image as described in conjunction with FIG. 2 may be stored in a memory such as memory 208. The root image may be fetched from the memory at the time of insertion of ruled-lines. In another embodiment of the invention, the print output generator may insert the ruled-lines during a half-toning operation by applying one or more algorithms. Finally, at 522, a printing mechanism such as printing mechanism 210 may print the print output on the target media sheet.

The image forming device and the method described above generates a print output in an image forming device by providing alternative ways or methods. The image forming device may also reduce the consumption of print media, such as paper sheets, considerably as the same paper may be used for taking the notes instead. This thus makes the image forming device environmental friendly. Moreover, the image forming device may also reduce the paper volume accumulation rate for a user. Hence, the image forming device eliminates the need for maintaining a separate set of pages having ruled-lines for taking notes.

One or more components of the image forming device for generating a print output by inserting one or more images such as ruled-lines, as described above with respect to various embodiments of the present invention, may be embodied in the form of a computer readable program code for a computer system. Typical examples of a computer system includes a general-purpose computer, a programmed microprocessor, a micro-controller, a peripheral integrated circuit element, and other devices or arrangements of devices that are capable of implementing the functions and operations described above.

Such a computer system comprises a computer, an input device and a display unit. The computer may include a microprocessor and memory, both volatile and non-volatile. The computer system may further include a storage device such as a disk drive (hard disk drive, optical disk drive or solid state drive). The storage device can also be other similar means for loading computer programs or other instructions into the computer system. The computer system may also include a communication unit for accessing other databases and the Internet through an I/O interface. The communication unit may allow the transmission as well as reception of data from other databases. The communication unit may include a modem, an Ethernet card, or any other device which enables the computer system to connect to databases and networks such as LAN, MAN, WAN and the Internet. The computer system may facilitate inputs from a user through input device, accessible to the system through the I/O interface.

The computer system executes a set of instructions that are stored in one or more computer usable mediums, in order to process input data. The storage elements may also hold data or other information as desired. The storage element may be in the form of an information source or a physical memory element present in the processing machine.

The set of instructions may include various commands that instruct the computer system to perform the specific tasks and operations described above. The set of instructions may be in the form of a software program. Further, the software may be in the form of a collection of separate programs, a program module with a larger program or a portion of a program module. The software may also include modular programming in the form of object-oriented programming. The processing of input data by the processing machine may be in response to user commands, results of previous processing or a request made by another processing machine.

The foregoing description of several methods and embodiments of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for generating a print output in an image forming device, the method comprising:
analyzing an input image, relative to a target media sheet and identifying at least one white space region having a size which exceeds a predetermined size; and
generating the print output comprising inserting one or more predefined images in the identified at least one white space region.

2. The method of claim 1 further comprising excluding one or more predefined areas from the print output.

3. The method of claim 1 further comprising printing the print output on at least one sheet of media.

4. The method of claim 1, wherein the inserting is selectively performed based upon determining at least one of whether the print output is single-sided, whether the print output is monochrome and whether the target media sheet is plain paper.

5. The method of claim 1 further comprising receiving a confirmation from a user regarding inserting the one or more predefined images in the identified at least one white space region.

6. The method of claim 1 further comprising storing a root image of the one or more predefined images in a memory of the image forming device.

7. The method of claim 1, wherein the inserting comprises inserting the one or more predefined images during a half-toning operation.

8. The method of claim 1, wherein the one or more predefined images comprises one or more ruled-lines.

9. The method of claim 8 further comprising storing a root image of the one or more ruled-lines in a memory of the image forming device in the form of at least one of a single line with spacing, a single line without spacing, a tile and a vector graphic.

10. The method of claim 8, wherein the one or more ruled-lines are inserted in the form of at least one of one or more horizontal ruled-lines and one or more vertical ruled-lines in the identified at least one white space region.

11. The method of claim 1, wherein the one or more predefined images are inserted on the reverse side of the target media sheet.

12. The method of claim 1, wherein at least one of color, darkness, size, and spacing of the one or more predefined images is adjustable by a user.

13. An image forming device comprising:
an input image analyzer for analyzing an input image, relative to a target media sheet;
a white space identifier for identifying at least one white space region having a size which exceeds a predetermined size;
a print output generator for generating a print output comprising inserting one or more predefined images in the identified at least one white space region; and
a printing mechanism for printing the print output on the target media sheet.

14. The image forming device of claim 13, wherein the print output generator excludes one or more predefined areas from the print output.

15. The image forming device of claim 13, wherein the print output generator selectively inserts the one or more predefined images based upon whether the print output is single-sided, whether the print output is monochrome and whether the target media sheet is plain paper.

16. The image forming device of claim 13 further comprising a user interface, wherein the print output generator is activated following receipt of a user input at the user interface to generate the print output with the one or more predefined images.

17. The image forming device of claim 13 further comprising a memory for storing a root image of the one or more predefined images.

18. The image forming device of claim 13 further comprising computer program code for providing a print preview to a user on a display device, wherein the print preview comprises the print output with the input image and the one or more predefined images inserted in the identified at least one white space region.

19. The image forming device of claim 13 further comprising a processor, wherein the input image analyzer, the white space identifier and the print output generator comprises computer program code for execution by the processor.

20. A computer program product for use with a processor for generating a print output in an image forming device, the computer program product comprising a computer usable medium having a computer readable program code embodied therein which, when executed by the processor, causes the image forming device to perform:
analyzing an input image, relative to a target media sheet and identifying at least one white space region having a size which exceeds a predetermined size; and
generating the print output comprising adding one or more predefined images in the identified at least one white space region.
